(19) United States
(12) Patent Application Publication
(10) Pub. No.: US 2013/0010362 A1
(43) Pub. Date: Jan. 10, 2013

(54) DIFFRACTIVE OPTICAL ELEMENT AND IMAGING APPARATUS USING THE SAME

(75) Inventors: Tomokazu TOKUNAGA, Hyogo (JP); Toshiaki TAKANO, Osaka (JP); Koji FUJII, Osaka (JP); Tetsuya SUZUKI, Osaka (JP)

(73) Assignee: PANASONIC CORPORATION, Osaka (JP)

(21) Appl. No.: 13/539,636

(22) Filed: Jul. 2, 2012

(30) Foreign Application Priority Data
Jul. 5, 2011 (JP) 2011-148915
May 21, 2012 (JP) 2012-115736

(51) Int. Cl. G02B 27/42

(52) U.S. Cl. 359/558

(57) ABSTRACT

A diffractive optical element includes a first optical member, a second optical member, and a third optical member stacked on each other in this order in an optical axis direction. A diffractive surface including a plurality of raised parts is formed at an interface between the first and second optical members. The first and third optical members contact each other at part other than the raised parts.

### CROSS-REFERENCE TO RELATED APPLICATION

This application claims priority to Japanese Patent Application No. 2011-148915 filed on Jul. 5, 2011 and Japanese Patent Application No. 2012-115736 filed on May 21, 2012, the disclosure of which including the specification, the drawings, and the claims is hereby incorporated by reference in its entirety.

### TECHNICAL FIELD

The instant application relates to a diffractive optical element and an imaging apparatus including the diffractive optical element.

### BACKGROUND

Conventionally, a diffractive optical element in which several optical members are stacked so as to closely contact each other and a relief pattern is formed at an interface between the optical members has been known.

For example, a diffractive optical element of Japanese Patent Publication No. H9-127321 is configured such that several optical members are stacked on each other and a boundary surface between the optical members is formed by a diffractive grating having a serrated cross-sectional shape.

For manufacturing the diffractive optical element of this type, the optical member having a diffractive surface and made of a glass material is formed, and, e.g., an ultraviolet curable resin material is applied onto the diffractive surface. The resin material is irradiated with ultraviolet light and is cured, and therefore a resin layer is formed. However, in the diffractive optical element manufactured in the foregoing manner, a surface of the resin layer on an opposite side of the diffractive surface may be corrugated in accordance with the shape of the diffractive surface.

In one general aspect, the instant application describes a diffractive optical element in which a corrugated surface is less likely to be formed in accordance with the shape of a diffractive surface and variation in thickness of a resin layer is reduced.

### SUMMARY

A diffractive optical element of the instant application includes a first optical member, a second optical member, and a third optical member stacked on each other in this order in an optical axis direction. A diffractive surface including a plurality of raised parts is formed at an interface between the first and second optical members, and the first and third optical members contact each other at part other than the raised parts.

### BRIEF DESCRIPTION OF THE DRAWINGS

FIG. 1 is a schematic cross-sectional view illustrating a diffractive optical element.

FIG. 2 is an enlarged cross-sectional view of part of the diffractive optical element.

FIGS. 3A-3E are views schematically illustrating steps for manufacturing the diffractive optical element.

FIG. 4 is a schematic cross-sectional view of a diffractive optical element of a variation.

FIG. 5 is a schematic cross-sectional view of an imaging apparatus.

### DETAILED DESCRIPTION

In the following detailed description, numerous specific details are set forth by way of examples in order to provide a thorough understanding of the relevant teachings. However, it should be apparent to those skilled in the art that the present teachings may be practiced without exemplary details. In other instances, well-known methods, procedures, components, and/or circuitry have been described at a relatively high-level, without detail, in order to avoid unnecessarily obscuring aspects of the present concepts. Exemplary embodiments will be described below in detail with reference to drawings.

### First Embodiment

### Configuration

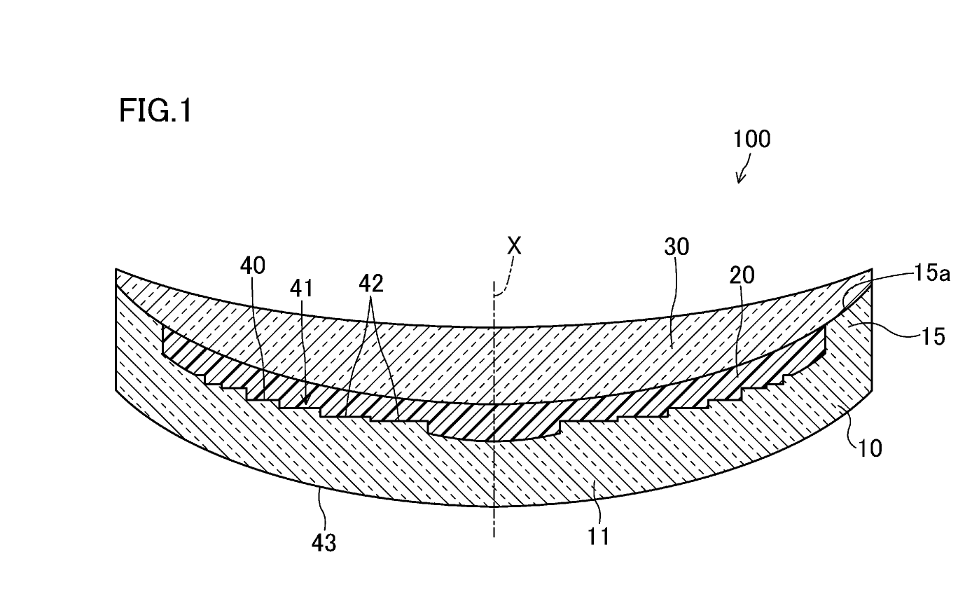

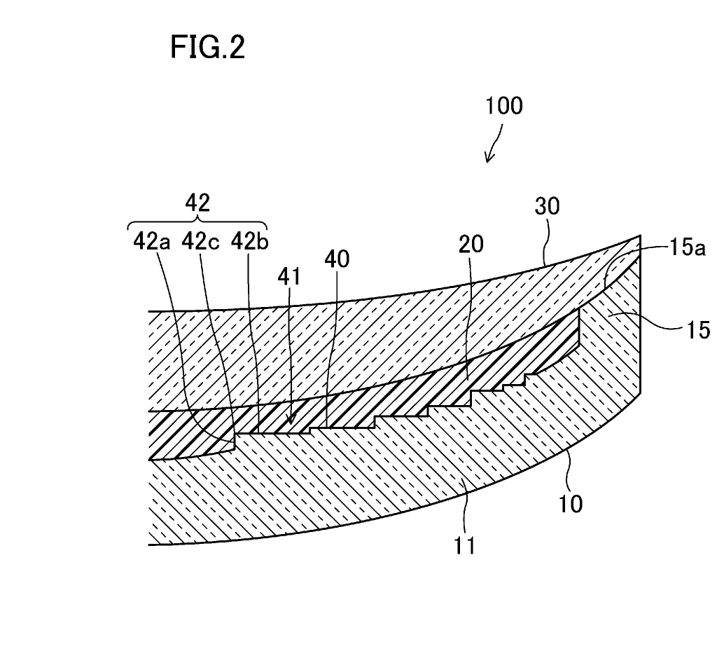

FIG. 1 illustrates a schematic cross-sectional view of a diffractive optical element 100, and FIG. 2 illustrates an enlarged cross-sectional view of part of the diffractive optical element 100.

The diffractive optical element 100 is a multilayer diffractive optical element in which a first optical member 10, a second optical member 20, and a third optical member 30 are stacked in this order so as to closely contact each other. Each of the first to third optical members 10, 20, 30 has light permeability. Specifically, the first and third optical members 10, 30 are made of a glass material. The second optical member 20 is made of a resin material. Note that the first and third optical members 10, 30 may be made of the same glass material, or may be made of different glass materials. Alternatively, the first and third optical members 10, 30 may be made of the same material as that of the second optical member 20.

The first and second optical members 10, 20 are coupled together. The first optical member 10 has two optical surfaces. One of the optical surfaces of the first optical member 10 is a diffractive surface 40 having a diffractive grating 41. The other optical surface 43 is an aspherical surface. Note that the optical surface 43 is not limited to the aspherical surface, and may be, e.g., a flat surface, a spherical surface, or a diffractive surface.

The second optical member 20 is coupled to the diffractive surface 40 of the first optical member 10. A surface of the second optical member 20 coupled to the first optical member 10 is in a shape similar to that of the diffractive surface 40. That is, the diffractive surface 40 is formed at an interface between the first and second optical members 10, 20. Since optical power of the diffractive surface 40 has dependence on wavelength, the diffractive surface 40 gives substantially the same phase difference to light having different wavelengths to diffract the light having different wavelengths at different diffraction angles.

The third optical member 30 is coupled to a surface of the second optical member 20 on an opposite side of the surface of the second optical member 20 coupled to the first optical member 10. That is, the second optical member 20 is sandwiched between the first and third optical members 10, 30. The third optical member 30 has two optical surfaces. One of the optical surfaces is coupled to the second optical member 20. Each of the optical surfaces may be an aspherical surface. Note that the optical surface may be, e.g., a spherical surface, a flat surface, or a diffractive surface. In addition, each of the optical surfaces is in a different shape, or the optical surfaces may be in the same shape.

Next, the first optical member 10 will be described in more detail.

The first optical member 10 includes a base part 11 and the diffractive grating 41 integrally formed with the base part 11. The diffractive grating 41 is formed in a recessed-raised shape having periodicity.

The diffractive grating 41 includes a plurality of raised parts 42 each having a circular shape as viewed in plane and extending in a circumferential direction around an optical axis X of the diffractive optical element 100. In plan view, the plurality of raised parts 42 are regularly arranged in a concentric pattern around the optical axis X such that each forms a ring with a different diameter around the optical axis X. Each of the raised parts 42 includes a first surface 42a substantially parallel to the optical axis X (i.e., extending along the optical axis X), a second surface 42b mainly having a diffraction function, and a ridged part 42c connecting between the first and second surfaces 42a, 42b. In addition, each of the raised parts 42 has a substantially triangular cross section. The second surface 42b tilts to the optical axis X or faces toward the optical axis X. The ridged part 42c is one example of a connection part. The second surface 42b may be curved in an aspherical shape or a spherical shape.

A plurality of contact parts 15 are provided in a circumferential part of the first optical member 10 at the optical surface at which the diffractive surface 40 is formed. More specifically, the contact parts 15 are positioned on an outer side relative to the outermost raised part 42. The contact parts 15 are arranged apart from each other in the circumferential direction around the optical axis X. Each of the contact parts 15 protrudes farther toward the third optical member 30 than other part of the optical surface (diffractive surface 40). The contact parts 15 contact the third optical member 30 at tip end surfaces 15a thereof. The tip end surface 15a is formed in a curved shape along a surface of part of the third optical member 30 contacting the tip end surface 15a. Thus, the tip end surface 15a and the third optical member 30 are in surface contact with each other. By allowing the contact of the contact parts 15 to the third optical member 30, a relationship between the positions of the first and third optical members 10, 30 in an optical axis direction is determined. That is, a distance between the first and third optical members 10, 30 is determined by the contact parts 15. More specifically, the distance between the first and third optical members 10, 30 is determined such that the first and third optical members 10, 30 do not contact each other at the raised parts 42. A space between the first and third optical members 10, 30 is filled with the second optical member 20. Since the contact parts 15 and the third optical member 30 contact each other, variation in distance between the first and third optical members 10, 30 in the optical axis direction, i.e., variation in thickness of the second optical member 20 can be reduced.

Manufacturing Method

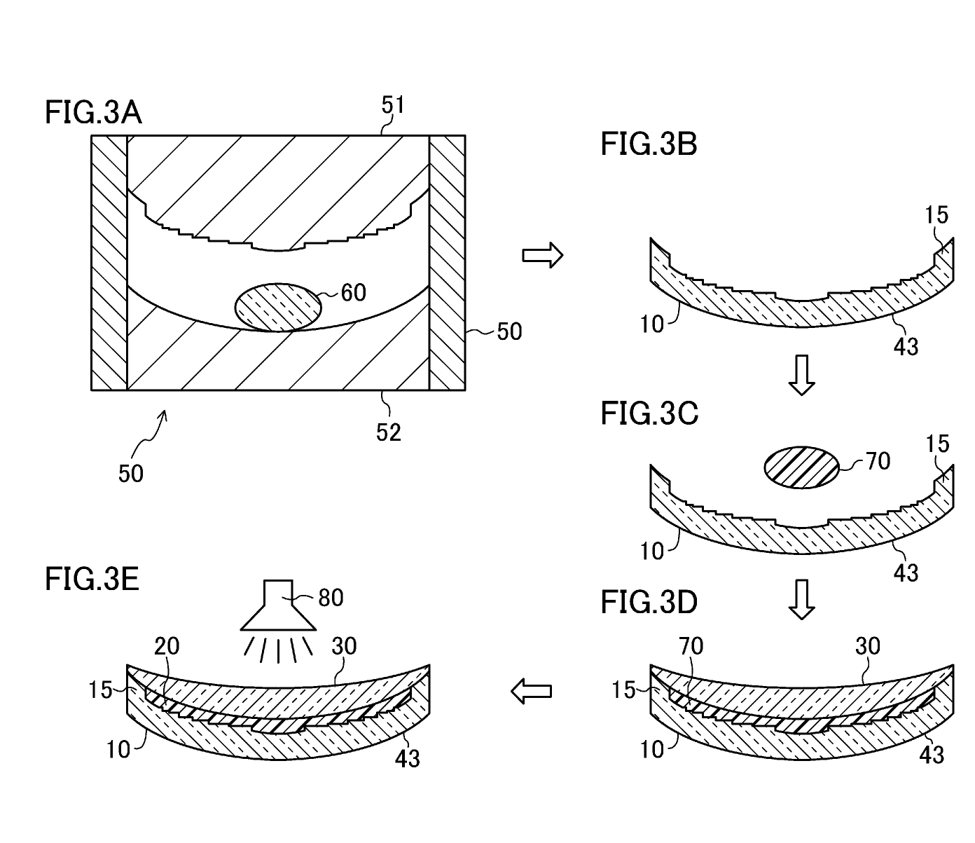

Next, a method for manufacturing a diffractive optical element 100 will be described. FIGS. 3A-3E schematically illustrate steps for manufacturing the diffractive optical element 100.

First, a mold 50 is prepared. The mold 50 includes an upper mold part 51, a lower mold part 52, a mold body 53. A molding surface of the upper mold part 51 has an inverted shape relative to the shape of a diffractive grating 41.

A base material of the upper mold part 51 is, e.g., cemented carbide or a ceramic material such as SiC. For example, a DLC film may be formed on the molding surface of the upper mold part 51 for detachability of the mold 50 from a glass material. As processing for forming the inverted shape relative to the shape of the diffractive grating 41, mechanical control processing such as grinding or cutting can be used to freely form a desired shape.

The mold 50 is filled with a glass material, and pressure is applied to the mold 50. Specifically, referring to FIG. 3A, an optical glass material 60 (e.g., a material manufactured as a product name of “VC79” by Sumita Optical Glass Inc. and having a Tg temperature of 516° C. and an At temperature of 553° C.) is applied onto a molding surface of the lower mold part 52, and then is heated to a desired temperature (e.g., about 580° C.) equal to or higher than the At temperature. Subsequently, a pressure device downwardly moves the upper mold part 51 along the mold body 53 to apply pressure to the optical glass material 60 (e.g., apply pressure of 200 kg for 40 seconds) and deform the optical glass material 60. Then, the optical glass material 60 is cooled to a predetermined temperature (e.g., 510° C.) close to the Tg temperature, and the upper mold part 51 is detached when the temperature of the optical glass material 60 reaches a temperature (e.g., 50-100° C.) at which the optical glass material 60 is removable. In the foregoing manner, a first optical member 10 is formed.

FIG. 3B illustrates the first optical member 10 formed in the foregoing manner. For example, the first optical member 10 has the following dimensions: an outer diameter φ of 38 mm; a thickness t of 4 mm; a radius of curvature of 100 mm for a base surface (surface formed by removing a diffractive grating 41 from a diffractive surface 40); and a radius of curvature of 50 mm for an optical surface 43 on an opposite side of the base surface.

Meanwhile, an optical glass material (e.g., a material manufactured as a product name of “S-FTM16” by Ohara Inc.) is formed into a third optical member 30 by polishing.

Next, referring to FIG. 3C, a resin material 70 (e.g., a material manufactured as a product name of “UV Epoxy Resin A-1631” by TESK Co., Ltd) is applied onto the diffractive surface 40 of the first optical member 10.

Referring to FIG. 3D, the third optical member 30 is pressed against the resin material 70 from above, thereby spreading the resin material 70 thin. Although not shown in the figure, the position of the first optical member 10 is determined by the mold, and the third optical member 30 is guided by the mold. Thus, an optical axis of the first optical member 10 and an optical axis of the third optical member 30 are coincident with each other. After a while, the third optical member 30 comes into contact with contact parts 15 of the first optical member 10. This determines a distance between the first and third optical members 10, 30. As a result, the thickness of the resin material 70 (second optical member 20) is determined.

The contact parts 15 of the first optical member 10 is arranged closer to the third optical member 30 than raised parts 42 of the diffractive grating 41 are. Thus, the raised parts 42 of the diffractive grating 41 do not contact the third optical member 30.

Next, referring to FIG. 3E, the resin material 70 is irradiated with ultraviolet light (e.g., a wavelength of 365 nm and an intensity of 50 mW) for 60 seconds by an ultraviolet light emitting device 80, and is cured. Subsequently, heat treatment is applied to the resin material 70 at 110° C. for 30 minutes in order to accelerate curing of the resin material 70. In the foregoing manner, a diffractive optical element 100 in which the first to third optical members 10, 20, 30 are stacked on each other is manufactured.

Advantages

In the diffractive optical element 100, the first to third optical members 10, 20, 30 are stacked on each other in this order. The diffractive surface 40 including the plurality of raised parts 42 is formed at the interface between the first and second optical members 10, 20, and the first and third optical members 10, 30 contact each other at part of the first optical member 10 other than the raised parts 42.

Specifically, the contact parts 15 are provided in the first optical member 10, and contact the third optical member 30. In other words, in at least one of the first and third optical members 10, 30, the contact parts 15 contacting the other one of the first and third optical members 10, 30 to determine the distance between the first and third optical members 10, 30 are provided.

If only the first and second optical members 10, 20 form the diffractive optical element, there is a possibility that the surface of the second optical member 20 on the opposite side of the diffractive surface 40 is corrugated in accordance with the shape of the diffractive surface 40. Considering the foregoing case, by further stacking the third optical member 30 on the second optical member 20, the foregoing corrugation in the diffractive optical element 100 can be reduced.

However, in the diffractive optical element including the plurality of layers, if the thickness of each of the layers varies, the thickness of the entirety of the diffractive optical element also varies. Particularly in the diffractive optical element in which at least three layers are stacked on each other, it is likely that the thickness of the middle layer (second optical member 20) varies. Considering the foregoing case, by allowing the contact between the first and third optical members 10, 30, the distance between the first and third optical members 10, 30 is determined, and therefore the variation in thickness of the second optical member 20 can be reduced. As a result, the high-grade diffractive optical element 100 can be easily manufactured with high positional accuracy of the first and third optical members 10, 30 and high thickness accuracy of the second optical member 20.

The first and third optical members 10, 30 are in non-contact with each other at the raised parts 42. In other words, the contact parts 15 determine the distance between the first and third optical members 10, 30 such that the first and third optical members 10, 30 do not contact each other at the raised parts 42.

According to the foregoing configuration, the yield rate of the diffractive optical element 100 can be improved. That is, depending on the hardness and strength of an optical glass material used for the first or third optical member 10, 30, there is a possibility that, when the raised parts 42 come into contact with the third optical member 30, the raised part(s) 42 may be cracked or a surface of the third optical member 30 may be scratched. In such a situation, the production yield rate is reduced.

On the other hand, since the contact parts 15 contacting the third optical member 30 reduce or prevent the contact between each of the raised parts 42 and the third optical member 30, the cracks of the raised part(s) 42 or the scratches of the third optical member 30 can be reduced or prevented. As a result, the high-yield diffractive optical element can be manufactured with the high positional accuracy of the first and third optical members 10, 30 and the high thickness accuracy of a second optical member 20.

Since the raised parts 42 and the third optical member 30 do not contact each other, a diffraction function of the diffractive surface 40 can be properly fulfilled. Specifically, on the precondition that mediums sandwiching the second surfaces 42b are the first and second optical members 10, 20, the second surfaces 42b are designed to fulfill a desired diffraction function. For the foregoing reason, if the second surfaces 42b and the third optical member 30 contact each other, the mediums sandwiching the second surfaces 42b are the first and third optical members 10, 30 at the contact point of the second surfaces 42b and the third optical member 30, and therefore the diffraction function of the second surfaces 42b cannot be properly fulfilled at the contact point. On the other hand, since the raised parts 42 and the third optical member 30 are in non-contact with each other, the diffractive surface 40 can properly fulfill the diffraction function thereof.

Note that, it can be easily checked by observing the cross section of the diffractive optical element 100 with a stereomicroscope or an electronic microscope (e.g., a microscope manufactured as a product name of “OLS1200” by Olympus Corporation) whether or not the first and third optical members 10, 30 contact each other at the raised parts 42.

The third optical member 30 contacts the first optical member 10 at the circumferential part of the first optical member 10. Specifically, the plurality of raised parts 42 are formed in the concentric pattern around the optical axis X such that each forms a ring with a different diameter around the optical axis X, and the third optical member 30 contacts the first optical member 10 on the outer side relative to the outermost raised part 42.

Thus, in a region of the diffractive surface 40 which has little influence on the diffraction function thereof, the first and third optical members 10, 30 can contact each other.

Variation

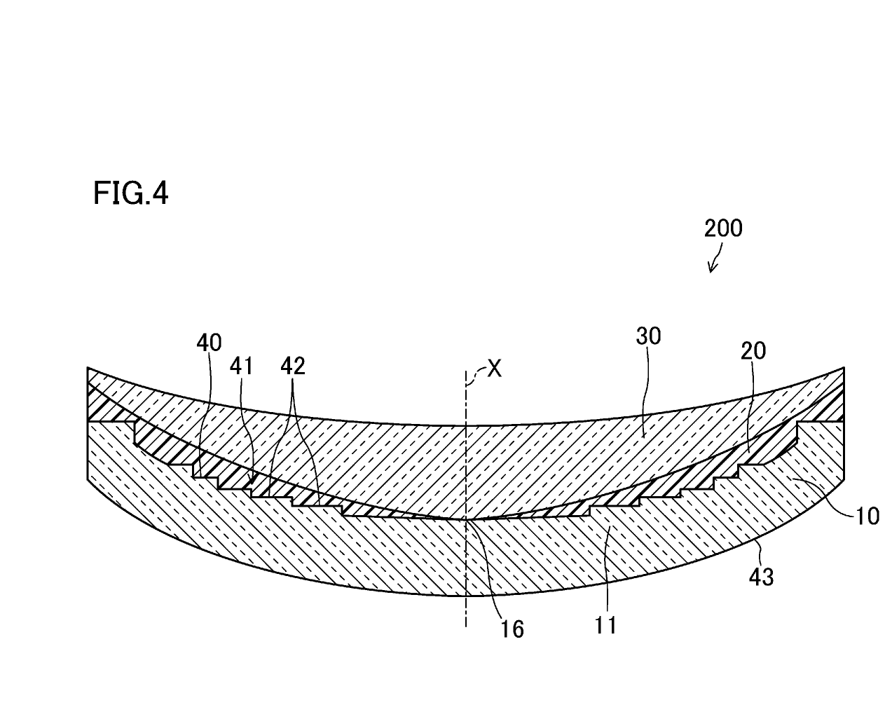

Next, a diffractive optical element 200 of a variation will be described with reference to FIG. 4. FIG. 4 illustrates a schematic cross-sectional view of the diffractive optical element 200 of the variation.

In the diffractive optical element 100, the first and third optical members 10, 30 contact each other at the circumferential part of the first optical member 10. However, in the diffractive optical element 200, first and third optical members 10, 30 contact each other at a center part of the first optical member 10.

Specifically, a contact part 16 is provided on an inner side relative to an innermost raised part 42 of the first optical member 10. The contact part 16 contacts a center part of the third optical member 30. In such a state, the first and third optical members 10, 30 do not contact each other at the raised parts 42.

As in the foregoing manufacturing method, when the third optical member 30 is pressed to spread a resin material 70 applied onto a diffractive surface 40 of the first optical member 10, the position of the first optical member 10 is determined by the mold, and the third optical member 30 is guided by the mold. Thus, even if the first and third optical members 10, 30 contact each other only at the center part of the first optical member 10, an optical axis of the first optical member 10 and an optical axis of the third optical member 30 are coincident with each other.

That is, in the diffractive optical element 200, the third optical member 30 contacts the first optical member 10 at the center part of the first optical member 10. Specifically, the plurality of raised parts 42 are formed in a concentric pattern around an optical axis X such that each forms a ring with a different diameter around the optical axis X, and the third optical member 30 contacts the first optical member 10 on the inner side relative to the innermost raised part 42.

According to the foregoing configuration, the high-grade diffractive optical element 200 can be easily manufactured with high positional accuracy of the first and third optical members 10, 30 and high thickness accuracy of a second optical member 20 as in the diffractive optical element 100.

Note that, in order to reduce or prevent inclination of the optical axes of the first and third optical members 10, 30, the first and third optical members 10, 30 may contact each other at the contact part 16 and a circumferential part of the first optical member 10, or may contact each other at some of the raised parts 42.

The contact part 16 may be in any shapes, and may be in a shape protruding toward the third optical member 30.

### Second Embodiment

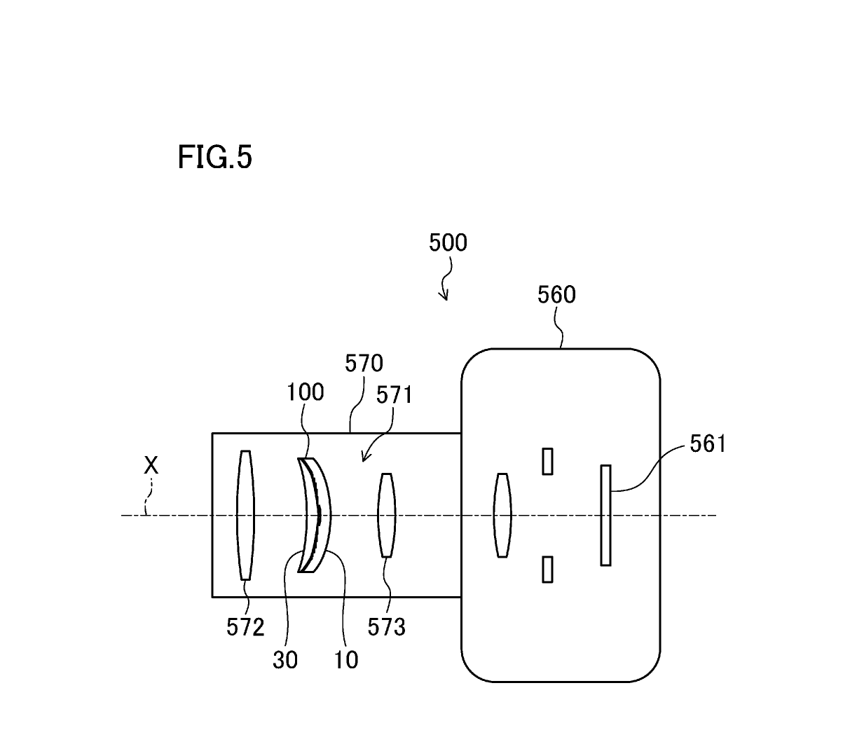

Next, a camera 500 of a second embodiment will be described with reference to a drawing. FIG. 5 illustrates a schematic view of the camera 500.

The camera 500 includes a camera body 560 and an interchangeable lens 570 coupled to the camera body 560. The camera 500 is an example of an imaging apparatus.

The camera body 560 includes an imaging element 561.

The interchangeable lens 570 is detachable from the camera body 560. The interchangeable lens 570 is, e.g., a telephoto zoom lens. The interchangeable lens 570 includes an imaging optical system 571 for focusing a light bundle on the imaging element 561 of the camera body 560. The imaging optical system 571 includes the diffractive optical element 100 and refracting lenses 572, 573. The diffractive optical element 100 functions as a lens element. The interchangeable lens 570 serves as an optical unit.

### Other Embodiments

Each of the foregoing embodiments may have the following configurations.

The contact parts 15 are provided in the circumferential part of the first optical member 10, but may be provided in part of the first optical member 10 other than the circumferential part.

Both of the contact parts 15, 16 may be provided.

The contact parts 15, 16 are provided in the first optical member 10, but the instant application is not limited to such a configuration. For example, the contact parts 15, 16 may be provided in the third optical member 30. Alternatively, contact parts may be provided in both of the first and third optical members 10, 30, and the first and third optical members 10, 30 contact each other at both of the contact parts of the first and third optical members 10, 30.

The materials of the first to third optical members 10, 20, 30 are not limited to the foregoing materials. For example, thermo-plastics may be used as the materials of the first and third optical members 10, 30.

An anti-reflection film may be formed on the diffractive surface 40 of the first optical member 10.

The base surface formed by removing the diffractive grating 41 from the diffractive surface 40 is formed in the spherical shape, but the instant application is not limited to such a base surface. The base surface of the diffractive surface 40 may be an aspherical surface or a flat surface.

The instant application is useful for the diffractive optical element including the diffractive surface and the imaging apparatus including the diffractive optical element.

It is understood that various modifications may be made in the foregoing embodiments, that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A diffractive optical element, comprising:
a first optical member, a second optical member, and a third optical member stacked on each other in this order in an optical axis direction,
wherein a diffractive surface including a plurality of raised parts is formed at an interface between the first and second optical members, and
the first and third optical members contact each other at part other than the raised parts.

2. The diffractive optical element of claim 1, wherein
the first and third optical members are in non-contact with each other at the raised parts.

3. The diffractive optical element of claim 1, wherein
the third optical member contacts the first optical member at a circumferential part of the first optical member.

4. The diffractive optical element of claim 1, wherein
the third optical member contacts the first optical member at a center part of the first optical member.

5. An imaging apparatus, comprising:
the diffractive optical element of claim 1.
